(19) United States
(12) Patent Application Publication
(10) Pub. No.: US 2026/0369856 A1
(43) Pub. Date: Nov. 19, 2026

(54) COMBINATION FOR INJECTION-LOCKED MAGNETRONS

(71) Applicant: Rivendell Environmental Technologies, Inc., Greenwich, CT (US)

(72) Inventor: Mark Adam Hudson Robertson, Carleton Place (CA)

(21) Appl. No.: 19/451,596

(22) Filed: Jan. 16, 2026

Related U.S. Application Data
(60) Provisional application No. 63/805,623, filed on May 14, 2025.

(51) Int. Cl. H01P 1/213; H01J 23/38; H01P 1/18; H01P 1/383

(52) U.S. Cl. CPC H01P 1/213; H01J 23/38; H01P 1/182; H01P 1/383; H01J 2225/50

(57) ABSTRACT

A magnetron system includes a first magnetron to outputs a first microwave signal, a second magnetron to output a second microwave signal, a first circulator device, a second circulator device, and a combiner. The first circulator device is electrically connected with the first magnetron and directs the first microwave signal to a selected port of the first circulator device and transmits a control signal to the first magnetron. The second circulator device is electrically connected to the second magnetron. The second circulator device directs the second microwave signal to a selected port of the second circulator device and transmits the control signal to the second magnetron. The combiner electrically connected with the first circulator device and the second circulator device. The combiner combines the first microwave signal and the second microwave signal to output a third microwave signal.

### CROSS-REFERENCE TO RELATED APPLICATIONS

This application claims priority to U.S. provisional application Ser. No. 63/805,623 filed May 14, 2025, the disclosure of which is hereby incorporated in its entirety by reference herein

### TECHNICAL FIELD

Various embodiments relate to magnetrons and, more particularly, to system and methods for electrical connection of magnetrons.

### BACKGROUND

Magnetrons are utilized to produce microwaves having a power and frequency for various purposes relating to various industries including plasma generation for synthetic diamond production, hydrogen production, acetylene production, food processing, radar applications, mining etc. As an example, magnetron sputtering is common in the mining industry. Continuous wave L-Band magnetrons generally have a power output capacity between 50 kW and 100 kW. This 100 kW capacity limits the potential usage of magnetrons in roles such as those relating to the aforementioned industries.

### SUMMARY

In an illustrative example, a magnetron system includes a first magnetron configured to output a first microwave signal, a second magnetron configured to output a second microwave signal, a first circulator device, a second circulator device, and a combiner. The first circulator device is electrically connected with the first magnetron and is configured to direct the first microwave signal to a selected port of the first circulator device and transmit a control signal to the first magnetron. The second circulator device is electrically connected to the second magnetron and the second circulator device is configured to direct the second microwave signal to a selected port of the second circulator device and transmit the control signal to the second magnetron. The combiner has a first port electrically connected with the first circulator device, a second port electrically connected with the second circulator device, and a third port electrically connected to an output. The combiner is configured to combine the first microwave signal and the second microwave signal to output a third microwave signal via the third port.

In some aspects, the magnetron system further includes a frequency control system electrically connected with the first circulator device and the second circulator device. The frequency control system is configured to define the control signal to adjust one or more signal characteristics of at least one of the first microwave signal or the second microwave signal.

In some aspects, the magnetron system further includes a first phase measurement and a second phase measurement device. The first phase measurement device is configured to measure a phase of the first microwave signal, where the one or more signal characteristics of the first microwave signal includes the phase of the first microwave signal. The second phase measurement device is configured to measure a phase of the second microwave signal, where the one or more signal characteristics of the second microwave signal includes the phase of the second microwave signal.

In some aspects, the frequency control system is configured to define the control signal to adjust the phase of the at least one of the first microwave signal and the second microwave signal based on the phases of the first microwave signal and the second microwave signal.

In some aspects, the first magnetron and the second magnetron are injection locked to output the first microwave signal and the second microwave signal at a specified frequency.

In some aspects, the magnetron system further includes a first radio frequency (RF) coupler and a second RF coupler. The first RF coupler is electrically connected to the first circulator device. The second RF coupler is electrically connected to the second circulator device.

In some aspects, the combiner is a magic tee coupler.

In some aspects, the magic tee coupler is electrically connected to the first circulator device and the second circulator device via the first RF coupler and the second RF coupler, respectively.

In some aspects, the magnetron system further includes a third RF coupler. A third port of the magic tee coupler is electrically connected with the third RF coupler to output the third microwave signal.

In some aspects, a system includes the magnetron system and a water treatment system electrically connected to the magnetron system to receive the third microwave signal from the combiner. The water treatment system is configured to treat water using the third microwave signal.

In some aspects, a system includes the magnetron system and a mining apparatus electrically connected to the magnetron system to receive the third microwave signal from the combiner. The mining apparatus is configured to process minerals using the third microwave signal.

In an illustrative example, a magnetron system includes a plurality of magnetrons, a plurality of circulators, and a combiner. The plurality of magnetrons is configured to output a plurality of microwave signals. A pair of circulators selected from the plurality of circulator is electrically connected to a magnetron among the plurality of magnetrons. A first circulator among the pair of circulators is configured to receive the microwave signal from the magnetron, and a second circulator among the pair of circulators is configured to transmit a control signal to the magnetron to control one or more signal characteristics of the microwave signal. The combiner is configured to output a unified microwave signal using the microwave signals from the first circulators of the pair of circulators.

In some aspects, the magnetron system further includes a frequency control system electrically connected with the second circulator among the pair of circulators. The frequency control system is configured to define the control signal to adjust the one or more signal characteristics of at least one of the microwave signals.

In some aspects, the magnetron system further includes a plurality of phase measurement devices configured to measure phases of the microwave signals generated by the plurality of magnetrons.

In some aspects, the frequency control system is configured to define the control signal to adjust a phase of the at least one of the microwave signals based on the phases of the microwave signals. The one or more signal characteristics includes the phase.

In some aspects, the plurality of magnetrons are injection locked to output the microwave signals at a specified frequency.

In some aspects, the magnetron system further includes a plurality of radio frequency (RF) couplers. Each RF coupler is electrically connected to the first circulator of the pair of circulators.

In some aspects, the combiner is a magic tee coupler, where the magic tree coupler is electrically connected to the plurality of RF couplers to receive the microwave signals.

In some aspects, the magnetron system further includes a post combination RF coupler electrically coupled to an output port of the magic tee coupler to receive and output the unified microwave signal.

In some aspects, the controls signal to one or more of the plurality of magnetrons is defined based on data from the post combination RF coupler and the plurality of RF couplers.

### BRIEF DESCRIPTION OF THE DRAWINGS

FIG. 1 is an example diagram showing a circuit layout for a magnetron output combiner.

FIG. 2 is an example diagram showing a circuit layout for a circulator set.

FIG. 3 is an example diagram showing a circuit layout for a radio frequency control system.

FIG. 4a is an example diagram showing a circuit layout for a single-stage magnetron output combiner.

FIG. 4b is an example diagram showing a circuit layout for a double-stage magnetron output combiner.

### DETAILED DESCRIPTION

Detailed embodiments are provided below. These embodiments, however, are intended solely as examples and may take various alternative forms and configurations. The accompanying figures are not drawn to scale; certain features may be exaggerated, minimized, or omitted to highlight specific details of particular components. Consequently, the structural and functional details described herein are not to be interpreted as limiting but rather as illustrative examples to guide those skilled in the art in applying the described concepts in different ways.

Magnetrons are utilized in various industries in order to generate electromagnetic signals in the microwave frequency. Generally, magnetrons have a limited power output of 100 kilowatts kW). It may be desirable in a given industry to increase the power output of magnetrons beyond 100 kW for specific applications. Therefore, those industries which utilize magnetrons may require a method and associated systems for amplifying magnetron power output beyond the current limit for separate magnetrons. One example industry which may benefit from such a method and associated system is mining which, as a further example, may utilize magnetron sputtering. Magnetron sputtering may be employed for depositing thin films of a selected material onto a substrate. In that process, a target having a desired deposition material is subjected to bombardment by gas ions, such as argon ions, which are accelerated by an applied electric field. The ion bombardment occurs within a vacuum chamber and results in the ejection of atomic-scale particles from the target surface through momentum transfer. These ejected particles traverse the vacuum chamber and are deposited onto the substrate surface, thereby forming the thin film

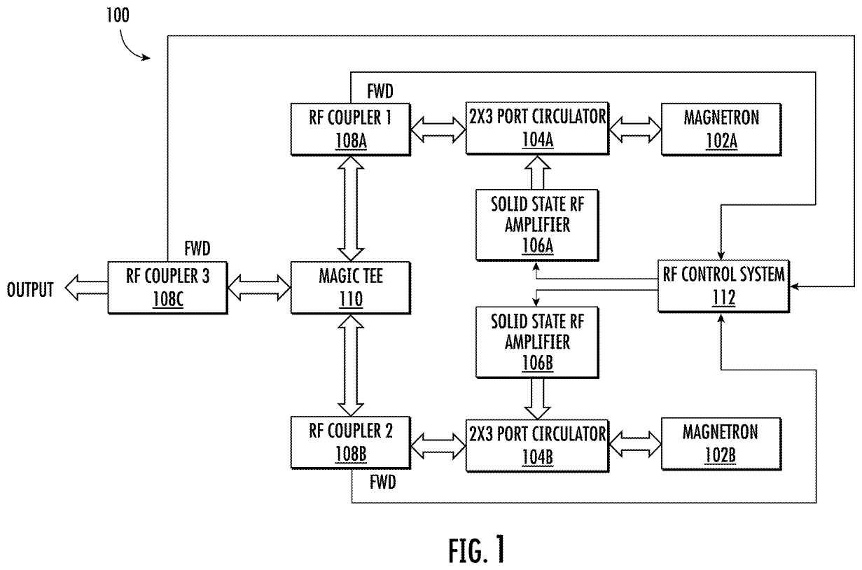

FIG. 1 illustrates an example circuit diagram of a magnetron combining system 100, which may also be referred to as the magnetron system 100, for combining magnetron outputs. Thick arrows represent electrical connections which are utilized for high power functions (e.g., power output) whereas thinner arrows represent electrical connections which are utilized for low power functions (e.g., phase and frequency adjustments). Additionally, where suitable, wireless connections may be utilized.

In some aspects, the system 100 includes magnetrons 102A, 102B, port circulator devices 104A, 104B, solid state radio frequency (RF) amplifiers 106A,106B, RF couplers 108A, 108B, 108C, and a combiner 110 (e.g., a magic tee). In the following, reference numbers having alphabetic notation “A”, “B”, “C”, “D”, etc., may be referred to as “first,” “second,” “third,” “fourth,” etc. For example, magnetrons 102A, 102B may be referred to as a first magnetron 102A and a second magnetron 102B.

As mentioned above, magnetrons generally have an output capacity range of 50 kW-100 kW. The magnetrons described in the examples contemplated herein have an output capacity of 100 kW. It will be understood, however, that the system described herein may be utilized to combine the outputs of magnetrons having any power output capacity, even a capacity beyond 100 kW. Furthermore, though the magnetrons described herein are continuous L-band magnetrons, it will be understood that any magnetron may be utilized in a non-continuous arrangement (e.g., pulsing).

The first magnetron 102A and the second magnetron 102B are electrically connected to the first port circulator device 104A and the second port circulator 104B, and configured to output microwave signals (e.g., a first microwave signal and a second microwave signal) to respective circulator device 104A, 104B, respectively. Microwave signals refer to electromagnetic radiation having wavelength within the microwave range corresponding to frequencies within the range of approximately 300 Megahertz to 300 Gigahertz. Magnetrons 102A, 102B may produce microwave signals by heating a filament (e.g., a cathode) which in turn emits electrons. A magnetic field may be produced about the magnetrons 102A, 102B which causes the emitted electrons to travel about the interior of the magnetrons 102A, 102B thereby influencing power output. The magnetic field may be produced by a plurality of magnets, a single magnet of suitable size, electromagnets, etc. positioned about the magnetrons 102A, 102B (e.g., supported by structures positioned proximate to the magnetrons 102A, 102B). During travel the electrons pass by cavities (e.g., anodes) positioned within the magnetrons 102A, 102B which cause the electrons to resonate at frequencies within the microwave range. The electromagnetic fields produced by the resulting resonating electrons may be transported between components in the system 100 via electrical connections such as cables or wires.

The first solid state RF amplifier 106A and the second solid state RF amplifier 106B are electrically connected to the first port circulator device 104A and the second port circulator device 104B, respectively. Each of the RF amplifiers 106A, 106B is configured to injection lock the magnetron 102A, 102B to which it is electrically connected via one of the port circulators 104A, 104B, as described below.

The first RF coupler 108A and the second RF coupler 108B are electrically connected with the first port circulator 104A and the second port circulator 104B, respectively. The first and second RF couplers 108A, 108B are each configured to measure a phase of the first microwave signal and second microwave signal, respectively.

The first and second RF couplers 108A, 108B may be electrically connected to the combiner 110 to provide the first and second microwave signals. The combiner 110 may be a magic tee, as illustrated in the drawings. However, other suitable electric combiners may be employed such as, but not limited to, a Wilkinson power divider-combiner, a hybrid 90 coupler, and/or a key junction. The combiner 110 is electrically connected to the third RF coupler 108C, which in return is connect to a desired receiver (not shown) of the microwave signal.

The system 100 further includes an RF control system 112 configured to generate and output an injection signal or control signal to injection lock the magnetrons 102A, 102B. The RF control system 112 is connected to the port circulator devices 104A, 104B via the solid state RF amplifiers 106A, 106B and configured to inject the control signal to the microwave signals generated by the magnetrons 102A, 102B. Magnetron injection locking (that is, frequency locking) refers to injecting a high-stability low-power external signal (e.g., “control signal”) into a low-stability high-power magnetron. When the power and frequency of the control signal meet a certain condition, the frequency and phase of the output of the magnetrons 102A, 102B will follow the frequency and phase of the injected external signal. In this way the phase and frequency of a high-power oscillator may be controlled through a small signal. The phase and/or frequency of the microwave signals may be referred to as signal characteristic(s) of the microwave signal. The control signal is provided to each magnetron 102A, 102B with the amplitude and the frequency of the control signal being the same. Each magnetron 102A, 102B may have a unique phase relationship that is constantly adjusted by respective control signal.

In some implementations, the control signal may be output by the RF control system 112 based on a frequency input from a user. The RF control system 112 may adjust the control signal overtime based on variation of the microwave signal frequency. For example, an L band 100KW magnetron outputs microwaves signal with a frequency from 913 MHz to 918 MHz. If a frequency of 915 MHz is chosen by a user, the RF control system 112 will output a control signal to lock the magnetrons 102A, 102B at the selected frequency of 915 MHz. Furthermore, the phase output of the magnetrons 102A, 102B may vary overtime based on magnetron power output stability resulting from varying power supply stability. The RF control system 112 may adjust the control signal in order to adjust the phase of the microwave signals and maximize magnetron efficiency. In such a scenario the RF control system 112 may collect signal feedback from the couplers 108A, 108B, 108C and (e.g., via computer software described below) determine how to adjust the control signal in order to remain synchronized with the magnetron output.

The RF amplifiers 106A, 106B are configured to amplify the control signal, a low-power injection signal, from the RF control system 112 and transmit the amplified control signal to the port circulator device 104A, 104B. The RF amplifiers 106A, 106B may amplify the control signal to a level sufficient to influence the phase and frequency of the microwave signals output by the magnetrons 102A, 102B. The RF amplifiers 106A, 106B may be any type of amplifier configured for amplifying control signals, such as but not limited to low noise amplifiers, power amplifiers, bidirectional amplifiers, etc.

The port circulator devices 104A, 104B are configured to combine respective first and second microwave signals with the control signal such that the microwave signals are frequency locked with the control signal (e.g., via injection locking describe above). The port circulator devices 104A, 104B may be any suitable multi-port device which is configured to direct RF signals entering via one port to be output via another port. As an example, the port circulator device 104A, 104B may be a combination of three port circulators or four port circulators such that the control signal may be transmitted from the RF amplifiers 106A, 106B to the magnetrons 102A, 102B and the microwaves signals may be transmitted from the magnetron 102A, 102B to the RF couplers 108A, 108B.

As mentioned above, the system 100 may include a first, second, and third RF coupler 108A, 108B, 108C. The first and second RF couplers 108A, 108B may be electrically connected to the port circulator devices 104A, 104B, the combiner 110, and the RF control system 112 such that they may transmit the microwave signals and provide frequency data to the RF control system 112 for the purposes of injection locking. The third RF coupler 108C may be electrically connected to the output of the system 100 (may be referred to “system output”), the combiner 110, and the RF control system 112.

The RF couplers 108A, 108B, 108C may be any suitable device configured to manage the distribution and sampling of RF signals. The RF couplers 108A, 108B, 108C may include a plurality of ports, allowing them to split or combine signals between different circuits while maintaining signal integrity. The RF couplers 108A, 108B, 108C may be configured for power splitting (e.g., dividing an input signal into two or more output signals with specific power ratios), power combining (e.g., merging multiple input signals into a single output signal), signal sampling (e.g., diverting a portion of a signal for monitoring or analysis without disrupting the main signal path), and signal isolation (e.g., preventing undesired signals from affecting the main output signal).

The combiner 110 is electrically connected to the RF couplers 108B, 108B, 108C. That is, the combiner 110 is connected to the system output via the third coupler 108C and the first port circulator devices 104A, 104B via the first and second RF couplers 108A, 108B, respectively. The combiner 110 may include a plurality of ports. As an example, the combiner 110 may have a first port electrically connected with the first port circulator device 104A via the first RF coupler 108A, a second port electrically connected with the second port circulator device 104B via the second RF coupler 108B, and a third port electrically connected to the system output via the third RF coupler 108C. The combiner 110 may be configured to receive the first microwave signal via the first port and the second microwave signal via the second port and combine the first signal and the second signal to output a third signal to the third port. In this embodiment, the combiner 110 is a magic tee, but other suitable combiners may be used, as described above.

As mentioned above, the power output of magnetrons may be increased beyond 100 kW. The embodiments described herein provide methods and systems configured to amplify magnetron power output beyond the limit typically associated with individual magnetrons. These embodiments may be implemented in various industrial processes that utilize magnetrons and that operate effectively at power levels exceeding 100 kW. For instance, in some implementations related to water treatment, magnetrons operating at power outputs greater than 100 kW may be employed. By combining multiple continuous-wave magnetrons under synchronized frequency and phase control, the system enables scalable, efficient, and fault-tolerant delivery of microwave power suitable for both experimental and full-scale production environments.

In an illustrative water treatment example, a water treatment system is electrically connected to the magnetron system 100 and configured to treat water using the third microwave signal from the combiner 110. In water treatment processes the magnetron system 100 may be implemented as a controllable microwave power source coupled to a treatment chamber that receives either (i) contaminated water, (ii) concentrate/retentate streams, or (iii) spent treatment media. In one example, the magnetron system 100 is integrated downstream of primary filtration/clarification and is configured to process spent granular activated carbon (GAC) or other sorbent media removed from a contactor. The system 100 applies microwave energy (e.g., the third microwave signal to heat the media to a target temperature profile that drives desorption and thermal decomposition of retained organics and regenerates adsorption capacity; the regenerated media is then returned to service. In another example, the system 100 is integrated on a side-stream of the treatment train (e.g., brine, concentrate, or backwash) such that the side-stream is routed through a microwave reactor for controlled heating and degradation of contaminants prior to recycle, discharge, or further polishing. In yet another example, the magnetron system 100 is coupled to a microwave applicator positioned upstream of final disinfection/polishing to provide rapid thermal treatment of select process streams or media, where the phase-frequency control of the system 100 enables uniform heating, scalability, and fault-tolerant operation in continuous or batch modes.

In another illustrative example, the magnetron system 100 is employed in a mining and mineral processing industrial application. The mining apparatus is electrically connected to the magnetron system 100 to receive the third microwave signal from the combiner 110. The mining apparatus is configured to process minerals using the third microwave signal. In a mining and mineral processing workflow, the magnetron system 100 may be implemented as a scalable microwave power source coupled to a continuous or batch applicator positioned at one or more stages including pre-treatment of run-of-mine ore, post-crushing feed conditioning, or pre-leach/pre-roast processing. In one example, ore fragments are conveyed through a microwave applicator after primary crushing and before milling, where controlled microwave heating preferentially heats mineral phases and induces micro-fracturing or thermal stress to improve downstream comminution efficiency and liberation. In another example, the system is used prior to beneficiation to selectively heat and dry ore or concentrate to modify moisture content or thermal properties for sorting, separation, or handling. In a further example, the system is positioned upstream of hydrometallurgical leaching or thermal treatment/calcination, where microwave heating is applied to concentrate, tailings, or mineral residues to drive drying, phase change, or controlled temperature ramping to improve extraction kinetics or reduce reagent usage. The coherent magnetron-combining architecture supports high-power scaling with controllable field distribution and redundancy for industrial throughputs.

While specific water treatment and mining applications are described, the magnetron system 100 may be used in various other applications. These applications may include, but is not limited to, manufacturing and processing, such as sintering and densification of ceramics and metals, curing and bonding of polymers and composites, and the regeneration or activation of carbon-based adsorbents, catalysts, and materials. In energy and environmental systems, the technology can be applied to processes like microwave-assisted pyrolysis and plasma generation for hydrogen production, biochar formation, and waste treatment, including the destruction and mineralization of persistent contaminants such as PFAS in water, sewage and biosolids and the drying of sewage and biosolids. It can also be utilized in mineral processing for ore pre-treatment, enhanced comminution, and drying, as well as in the food and biochemical industries for sterilization, pasteurization, drying, and controlled thermal processing. In chemical and pharmaceutical manufacturing, it supports microwave-assisted synthesis, catalysis, and solvent-free reactions with high precision and repeatability.

Furthermore, the system 100 may be utilized in defense or aerospace applications; or advanced system applications requiring directed, coherent microwave energy for materials testing, rare earth mineral processing and magnet creation, electronic warfare, and plasma propulsion research.

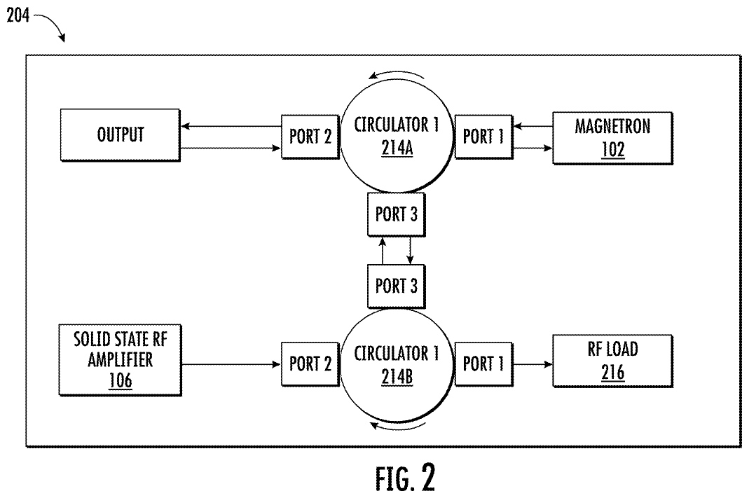

FIG. 2 is a diagram depicting an example circulator device 204 that may be used for one or both of the first and second port circulator devices 104A, 104B. In this example, the circulator device 204 includes a first circulator 214A and a second circulator 214B. Each of the circulators 214A, 214B may include a plurality of ports configured to input and output signals (e.g., port 1, port 2, port 3). The first circulator 214A may be electrically connected to the magnetron 102 via port 1, electrically connected to an output (e.g., coupler 108) via port 2, and electrically connected to the second circulator 214B via port 3. The second circulator 214B may be electrically connected to an RF load 216 via port 1, electrically connected to the RF amplifier 106 via port 2, and electrically connected to the first circulator 214A via port 3. It will be understood that, though in this example the circulator device 204 includes a pair of three port circulators 214A, 214B, the circulator device 204 may be a four-port circulator or any suitable arrangement of one or more circulators.

The relative orientation of the ports of circulators 214A and 214B may vary, so long as the configuration supports the intended direction of signal propagation The manner may include, for example, the signal flowing from the RF amplifier 106 through the circulators 214A, 214B to the magnetron 102, the microwave signals flowing from the magnetron 102 through the first circulator 214A to the output, and any reflected signals from the output flowing through the circulators 214A, 214B to the RF load. In other words, instead of the second circulator 214B having its port 3 connected to the first circulator 214A, the port 1 or port 2 of the second circulator 214B could be connected to the port 3 of the first circulator 214A and respectively the RF amplifier 106 and RF load 216 could be connected to the other two ports of the second circulator 214B.

Furthermore, the described pairing of circulators 214A, 214B and devices allows for the minimal amount of high-power RF loss. This is because the high-power signal (e.g., microwave signal) only passes through one circulator 214A and not both circulators 214A, 214B. This circuit can also be implemented by connecting the magnetron 102 and RF amplifier 106 to the first circulator 214A and thus the RF load 216 and output terminals on the second circulator 214B, but this would force the high-power output to flow through both circulators 214A, 214B, increasing any losses in the system.

The circulators 214A, 214B and/or circulator device 204 may be any device configured to direct RF signals entering one port to exit via a second port in a specific sequence. This may be achieved by using magnetized ferrite materials which create a preferred direction of signal propagation due to gyromagnetic properties.

The RF load 216 may be any suitable device configured to absorb reflected RF signals and terminate signal paths. The RF load 216 may specifically be designed to match the impedance of a transmission line so as to prevent reflection of RF signals.

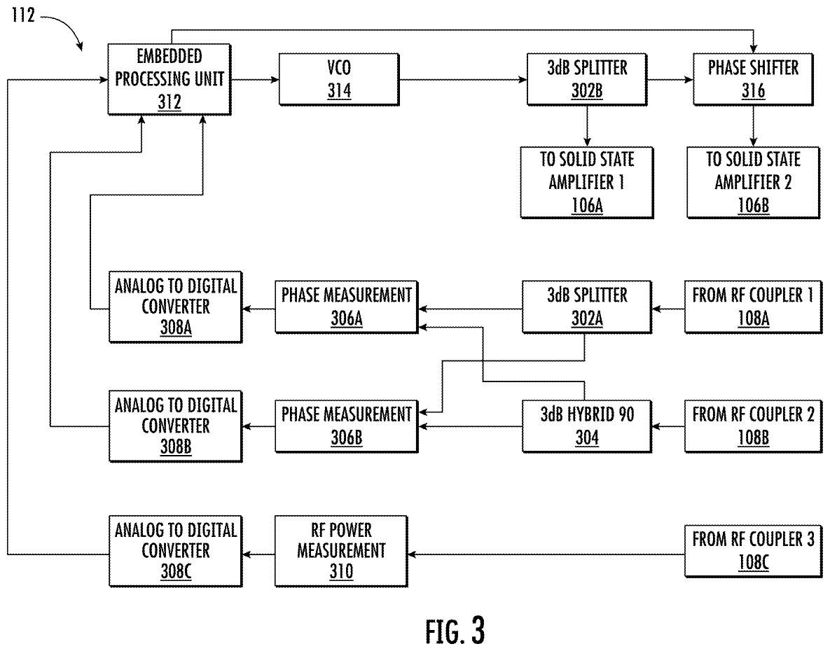

FIG. 3 depicts an example circuit diagram of the RF control system 112. The RF control system 112 is a device or arrangement of devices configured to adjust a frequency and a phase of the microwave signals which are output by the magnetrons 102A, 102B (e.g., via injection locking as described above). The RF control system 112 may receive an input indicating a specified frequency and/or phase for the first and second microwave signals and generate a control signal that is configured to conform the microwave signal frequency to the specified frequency as well as generate a phase delay to conform the microwave signals to the specified phase number. In a non-limiting example, the control signal is generated using stored algorithms and/or lookup tables. In addition, the RF control system 112 may generate the control signal and phase delay based on data received from various devices described below and may actuate the frequency and phase number of the signals via further devices described below.

The RF control system 112 may include a first 3 dB splitter 302A electrically connected to the first RF coupler 108A, a first phase measurement system 306A electrically connected to the first 3 dB splitter 302A, and a first analog to digital converter 308A electrically connected to the first phase measurement system 306A. The RF control system 112 may further include a 3 dB hybrid-90 304 electrically connected to the second RF coupler 108B as well as the first phase measurement system 306A, a second phase measurement system 306B electrically connected to the 3 dB hybrid-90 304 as well as the first 3 dB splitter 302A, and a second analog to digital converter 308B.

The RF control system 112 may further include an RF power measurement system 310 electrically connected to the RF coupler 108C, and a third analog to digital converter 308C. The RF control system 112 may further include an embedded processing unit (EPU) 312 electrically connected to each of the analog to digital converters 308A, 308B, 308C. The RF control system 112 may further include a voltage-controlled oscillator (VCO) 314 electrically connected to the EPU 312, a second 3 dB splitter 302B electrically connected to the VCO 314 and the first RF amplifier 106A, and a phase shifter 316 electrically connected to the second 3 dB splitter 302B, the second RF amplifier 106B, and the EPU 312.

The 3 dB splitter 302A, 302B may be any device configured to split an input signal into two or more output signals with equal power. The 3 dB splitter 302A is configured to split the low power signal from the first coupler 108A such that the low power signal may be transmitted to the first and second phase measurement systems 306A, 306B. Similarly, the 3 dB hybrid 90 may be any device configured to split an input signal into two or more output signals with equal power and also apply a 90-degree phase shift to one of the output signals.

In the example of FIG. 3, the RF control system 112 implements two phase measurement systems 306A, 306B. Each of the phase measurement systems 306A, 306B may be a phase measurement device configured to measure the phase of the input signal from the 3 dB splitter 302A and the 3 dB hybrid 90. The phase measurement systems 306A, 306B may be, for example, an oscilloscope, a spectrum analyzer, etc.

The first system 306A receives both coupled RF signals with no phase manipulation. The second system 306B receives one of the coupled RF signals with a 90-degree phase performed by the 3 dB hybrid 90 304. This approach is referred to as phase quadrature measurement to have the measured data plotted and interpreted on a phasor diagram with an X (phase measurement 1) and Y (phase measurement 2) component. This approach may eliminate error in data processing and also circumvents the inherent phase measurement limitations of commonly available phase measurement devices. The data acquired from this phase measurement stage is used to control the phase shifter 316 which shifts the output phase of one RF amplifier 106A with respect to the other RF amplifier 106B.

Phase quadrature measurement is a process of phase measurement involving analyzing (e.g., by the EPU 312) signals that are 90 degrees out of phase with each other, known as in-phase (I) and quadrature (Q) components. In-phase components are typically represented by cosine waves, while quadrature components are represented by sine waves. By measuring these components, phase quadrature measurement allows for precise characterization of signal modulation, including amplitude modulation, frequency modulation, and phase modulation. The process involves summing the I and Q signals, which can produce a resultant signal with a phase that is a combination of the individual phases.

The RF power measurement system 310 may be a device or arrangement of devices configured to measure the power output of the system 100 as output from the third RF coupler 108C. The RF power measurement system 310 may, for example, be a spectrum analyzer.

The analog to digital converters 308A, 308B, 308C are electrically connected to the first phase measurement system 306A, the second phase measurement system 306B, and the RF power measurement system 310, respectively. The analog to digital converters 308 may be any suitable device configured to transform continuous analog signals into discrete digital signals. The conversion process involves sampling, quantization, and encoding such that the signals may be mapped to a finite set of values readable by the EPU 312. The analog to digital converters 308A, 308B, 308C may be any specified resolution that is desired in order to render digital signals of varying accuracy or signal reconstruction.

The EPU 312 is configured to receive input signals from the analog to digital converters 308 indicative of phase and frequency of the RF signals, and transmit signals to actuate other components based on the input signals. For example, the EPU 312 is configured to receive the specified frequency and/or phase from, for example, a user via an input interface. The EPU 312 then actuates the VCO 314 to produce the control signal, as described below. The EPU 312 may also store instructions to continuously adjust a phase and/or frequency of the control signal based on any frequency/phase changes of the magnetrons 102A, 102B over the course of operations.

The EPU 312 may be a controller such as a computer having a processor and a memory which may store instructions executable by the processor to carry out specified functions. The EPU 312 may be provided as one or more controllers or may refer to an arrangement of controllers. The EPU 312 may coordinate operations of modules, machines, subsystems, etc. associated the system 100. The EPU 312 is in electric communication with the devices, modules, and systems of the magnetron system 100 and is configured to coordinate functionality of the system 100. The EPU 312 may be a facility-based computing system that includes one or more controllers that communicate via a serial bus or via dedicated electrical conduits. The EPU 312 may include any number of microprocessors, ASICs, ICs, memory (e.g., FLASH, ROM, RAM, EPROM and/or EEPROM) and software code to co-act with one another to perform a series of operations. The EPU 312 also includes predetermined data, or “lookup tables,” that are based on calculations and test data, and are stored within the memory. The EPU 312 may communicate with various systems and/or other controllers over one or more wired or wireless connections using common bus protocols (e.g., CAN and LIN). Used herein, any reference to “a controller” refers to one or more controllers.

The EPU 312 may communicate with various sensors and actuators via an input/output (I/O) interface that may be implemented as a single integrated interface that provides various raw data or signal conditioning, processing, and/or conversion, short-circuit protection, and the like. Alternatively, one or more dedicated hardware or firmware chips may be used to condition and process particular signals before being supplied to the CPU. Although not explicitly illustrated, those of ordinary skill in the art will recognize various functions or components that may be controlled by a controller within each of the subsystems identified above. In this example, the EPU 312 may obtain data about the microwave signals and control signals (e.g., frequency and phase shift data) from various sensors supported by various devices in the system 100.

The VCO 314 may be any suitable electronic circuit configured to generate an oscillating signal having a frequency directly proportional to an input control voltage. The core of a VCO may include an LC circuit (e.g., an inductor and capacitor) or a ring oscillator, where the control voltage adjusts the capacitance or inductance, thereby changing the oscillation frequency. For the purposes of injection locking, the VCO 314 provides the control RF signal that is injected into the magnetron thereby influencing the magnetron's natural oscillation, causing it to lock onto the frequency and phase of the VCO 314 output. By continuously adjusting the control voltage, the VCO 314 can fine-tune the control signal, ensuring that the magnetron remains locked even in the presence of external perturbations.

The phase shifter 316 may be any device configured to adjust a phase of an input RF signal. Phase shifter 316 introduces a controlled delay to a signal which can be adjusted by the EPU 312 in order to achieve a specified phase shift. The phase shifter 316 may be implemented using various technologies, such as ferrite materials, varactor diodes, or digital circuits. By adjusting the phase of the input RF signal, the phase shifter 316 locks the magnetron 102A, 102B onto the desired frequency and phase, maintaining stable and coherent output. As an example, the EPU 312 controls the phase shifter to shift the phase of the control signal by a specified amount. As the output power of the magnetron 102A, 102B changes, the relative phase with respect to the control signal varies. Most power supplies used for magnetrons 102A, 102B have some variation in their output, resulting in power variation in the output of the magnetron 102A, 102B. Thus, constant monitoring and adjustment of the phase shifter by the EPU 312 may be desirable in order to maintain a synchronized phase between signals such that output power is optimized.

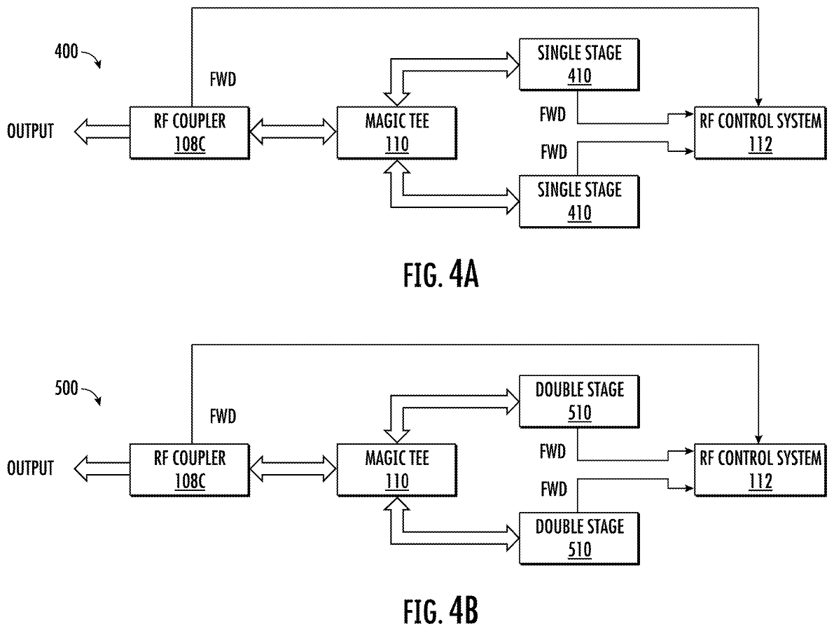

FIGS. 4A and 4B depict a double stage magnetron system 400 and quadruple stage magnetron system 500 respectively. As illustrated in FIG. 4A, two single stages 410 can be combined to make a double stage 510. Each of the single stages 410 comprises the RF amplifiers 106, magnetrons 102, circulator device 104, and couplers 108 as depicted in the magnetron combining system 100. The double stage magnetron system 400 comprises four magnetrons 102 being combined. Furthermore, the double stage systems 400 can be combined to make a quadruple stage as illustrated in FIG. 4B, that being eight magnetrons 102 combined together. The practical limit of this approach is determined by the power handling capabilities of the downstream components used (i.e. the magic tee, RF coupler and interconnecting waveguide between devices).

Computing devices such as those discussed herein generally each include commands executable by one or more computing devices such as those identified above, and for carrying out blocks or steps of processes described above. For example, process blocks discussed above may be embodied as computer executable commands.

Computer executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands (i.e., from a memory, a computer readable medium, etc.) and executes these commands, thereby performing one or more processes, including one or more of the processes described herein. Such commands and other data may be stored in files and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claimed invention.

Use of in response to, based on, and upon determining herein indicates a causal relationship, not merely a temporal relationship. “Based on” or “in response to” can mean based at least partly on or at least partly in response to unless explicitly stated otherwise.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the claimed invention.

What is claimed is:

1. A magnetron system comprising:
a first magnetron configured to output a first microwave signal;
a second magnetron configured to output a second microwave signal;
a first circulator device electrically connected with the first magnetron, the first circulator device being configured to direct the first microwave signal to a selected port of the first circulator device and transmit a control signal to the first magnetron;
a second circulator device electrically connected to the second magnetron, the second circulator device being configured to direct the second microwave signal to a selected port of the second circulator device and transmit the control signal to the second magnetron; and
a combiner having a first port electrically connected with the first circulator device, a second port electrically connected with the second circulator device, and a third port electrically connected to an output, the combiner being configured to combine the first microwave signal and the second microwave signal to output a third microwave signal via the third port.

2. The system of claim 1, further comprising a frequency control system electrically connected with the first circulator device and the second circulator device, the frequency control system being configured to define the control signal to adjust one or more signal characteristics of at least one of the first microwave signal or the second microwave signal.

3. The system of claim 2, further comprising:
a first phase measurement device configured to measure a phase of the first microwave signal, wherein the one or more signal characteristics of the first microwave signal includes the phase of the first microwave signal, and
a second phase measurement device configured to measure a phase of the second microwave signal, wherein the one or more signal characteristics of the second microwave signal includes the phase of the second microwave signal.

4. The system of claim 3, wherein the frequency control system is configured to define the control signal to adjust the phase of the at least one of the first microwave signal and the second microwave signal based on the phases of the first microwave signal and the second microwave signal.

5. The system of claim 1, wherein the first magnetron and the second magnetron are injection locked to output the first microwave signal and the second microwave signal at a specified frequency.

6. The system of claim 1, further comprising:
a first radio frequency (RF) coupler electrically connected to the first circulator device, and
a second RF coupler electrically connected to the second circulator device.

7. The system of claim 6, wherein the combiner is a magic tee coupler.

8. The system of claim 7, wherein the magic tee coupler is electrically connected to the first circulator device and the second circulator device via the first RF coupler and the second RF coupler, respectively.

9. The system of claim 7, further comprising a third RF coupler, wherein a third port of the magic tee coupler is electrically connected with the third RF coupler to output the third microwave signal.

10. A system comprising:
the magnetron system of claim 1; and
a water treatment system electrically connected to the magnetron system to receive the third microwave signal from the combiner, wherein the water treatment system is configured to treat water using the third microwave signal.

11. A system comprising:
the magnetron system of claim 1; and
a mining apparatus electrically connected to the magnetron system to receive the third microwave signal from the combiner, wherein the mining apparatus is configured to process minerals using the third microwave signal.

12. A magnetron system comprising:
a plurality of magnetrons configured to output a plurality of microwave signals;
a plurality of circulators, a pair of circulators selected from the plurality of circulators being electrically connected to a magnetron among the plurality of magnetrons, wherein a first circulator among the pair of circulators is configured to receive the microwave signal from the magnetron, and a second circulator among the pair of circulators is configured to transmit a control signal to the magnetron to control one or more signal characteristics of the microwave signal; and
a combiner configured to output a unified microwave signal using the microwave signals from the first circulators of the pair of circulators.

13. The system of claim 12, further comprising a frequency control system electrically connected with the second circulator among the pair of circulators, the frequency control system being configured to define the control signal to adjust the one or more signal characteristics of at least one of the microwave signals.

14. The system of claim 13, further comprising a plurality of phase measurement devices configured to measure phases of the microwave signals generated by the plurality of magnetrons.

15. The system of claim 14, wherein the frequency control system is configured to define the control signal to adjust a phase of the at least one of the microwave signals based on the phases of the microwave signals, wherein the one or more signal characteristics includes the phase.

16. The system of claim 12, wherein the plurality of magnetrons are injection locked to output the microwave signals at a specified frequency.

17. The system of claim 12, further comprising a plurality of radio frequency (RF) couplers, wherein each RF coupler is electrically connected to the first circulator of the pair of circulators.

18. The system of claim 17, wherein the combiner is a magic tee coupler, wherein the magic tree coupler is electrically connected to the plurality of RF couplers to receive the microwave signals.

19. The system of claim 18, further comprising a post combination RF coupler electrically coupled to an output port of the magic tee coupler to receive and output the unified microwave signal.

20. The system of claim 19, wherein the controls signal to one or more of the plurality of magnetrons is defined based on data from the post combination RF coupler and the plurality of RF couplers.
